(19) United States
(12) Patent Application Publication
(10) Pub. No.: US 2026/0225915 A1
(43) Pub. Date: Aug. 6, 2026

(54) METAL COMPLEX COMPOUND AND CATHODE ACTIVE SUBSTANCE INCLUDING THE METAL COMPLEX COMPOUND AS PRECURSOR

(71) Applicant: TANAKA CHEMICAL CORPORATION, Fukui (JP)

(72) Inventors: Chikako AMADA, Fukui (JP); Akari MAKIDA, Fukui (JP)

(73) Assignee: TANAKA CHEMICAL CORPORATION, Fukui (JP)

(21) Appl. No.: 19/462,211

(22) Filed: Jan. 28, 2026

(30) Foreign Application Priority Data
Jan. 31, 2025 (JP) 2025-015016

(51) Int. Cl. C01G 53/84; H01M 4/525

(52) U.S. Cl. CPC C01G 53/84; H01M 4/525; C01P 2004/51; C01P 2006/40

(57) ABSTRACT

A metal complex compound comprising at least nickel and an element M2, wherein the element M2 is at least one kind of element selected from the group consisting of Al, Mg, Ca, Sr, Ba, Ti, Zr, V, Nb, Cr, Mo, W, Fe, Ru, Cu, Zn, B, Ga, Si, Sn, P, and Bi, and wherein, in a volume-based particle size distribution of particles of the metal complex compound, obtained by measuring powder of the metal complex compound by static image analysis, when a particle diameter at a cumulative volume proportion of 10% from a small particle side is designated as D10 (μm) and a particle diameter at a cumulative volume proportion of 90% from the small particle side is designated as D90 (μm), a ratio (S90/S10) of an average solidity (S90) at the D90 to an average solidity (S10) at the D10 is larger than 1.000.

### CROSS REFERENCE TO RELATED APPLICATIONS

This application claims the benefit of foreign priority under 35 U.S.C. § 119 (a) to Japanese Patent Application No. 2025-015016, filed on Jan. 31, 2025, the entire contents of which are incorporated herein by reference.

### BACKGROUND

### Technical Field

The present disclosure relates to a metal complex compound, and a cathode active substance including the metal complex compound as a precursor.

### Description of the Related Art

A method for mixing and firing, for example, a lithium compound, and a metal complex compound containing a metal element other than lithium has been known as a method for producing a lithium metal complex oxide used for a cathode active substance for a lithium secondary battery.

In order to achieve characteristics of lithium secondary batteries such as improvement of cycle characteristics and improvement of lower resistance or increased output, studies have been made to control the physical properties of the particle shape and the like of the metal complex compound that is a raw material for a cathode active substance, within an appropriate range.

Japanese Patent Application Laid-Open No. 2022-146720 discloses nickel manganese complex hydroxide particles, which have a circularity of 0.87 to 0.97, as a precursor of a cathode active substance, and it is suggested that use of such a precursor can prepare a cathode active substance having a good charge-discharge capacity.

However, in the nickel manganese complex hydroxide particles having a circularity of 0.87 to 0.97, the handling property of the nickel complex hydroxide obtained as a product is deteriorated, and, furthermore, firing unevenness easily occurs in the production of the cathode active substance. Therefore, from the viewpoint of improving the battery performance of the lithium secondary batteries and production steps of the cathode active substances, there was room for further studying the shape of particles of the metal complex compound to be a precursor.

### SUMMARY

The present disclosure is related to providing a metal complex compound that can achieve both a good handling property and suppression of firing unevenness in the production of cathode active substances.

According to an aspect of the present disclosure, a metal complex compound comprising at least nickel and an element M2,
wherein the element M2 is at least one kind of element selected from the group consisting of Al, Mg, Ca, Sr, Ba, Ti, Zr, V, Nb, Cr, Mo, W, Fe, Ru, Cu, Zn, B, Ga, Si, Sn, P, and Bi, and
wherein, in a volume-based particle size distribution of particles of the metal complex compound, obtained by measuring powder of the metal complex compound by static image analysis, when a particle diameter at a cumulative volume proportion of 10% from a small particle side is designated as D10 (μm) and a particle diameter at a cumulative volume proportion of 90% from the small particle side is designated as D90 (μm), a ratio (S90/S10) of an average solidity (S90) at the D90 to an average solidity (S10) at the D10 is larger than 1.000.

In one embodiment of the present disclosure, the ratio (S90/S10) is less than 1.020.

In one embodiment of the present disclosure, when a particle diameter at a cumulative volume proportion of 5% from the small particle side is designated as D5 (μm) in the particle size distribution, an average solidity (S5) at the D5 is 0.993 or less.

In one embodiment of the present disclosure, the metal complex compound satisfies a compositional formula (A) described below,

$$Ni {(}_{1 - x \_ y} ) M {1}_{x} M {2}_{y} {{O}_{z} ( OH )}_{2 - t} \qquad ( A )$$

wherein, in the compositional formula (A), 0≤x≤0.7, 0<y≤0.2, 0≤z≤3, −0.5≤t≤2, and t−z<2 are satisfied,
M1 is one or more kinds of elements selected from Co and Mn, and
M2 is one or more kinds of elements selected from the group consisting of Al, Mg, Ca, Sr, Ba, Ti, Zr, V, Nb, Cr, Mo, W, Fe, Ru, Cu, Zn, B, Ga, Si, Sn, P, and Bi.

In one embodiment of the present disclosure, the metal complex compound is a precursor of a cathode active substance of a nonaqueous electrolyte secondary battery.

According to another aspect of the present disclosure, a cathode active substance of a nonaqueous electrolyte secondary battery, which is obtained by firing the metal complex compound with a lithium compound.

According to the metal complex compound of the present disclosure, when a ratio (S90/S10) of the average solidity is larger than 1.000, a metal complex compound, which can achieve both a good handling property and suppression of firing unevenness, can be provided in the production of cathode active substances.

Moreover, according to the metal complex compound of the present disclosure, when the average solidity (S5) is 0.993 or less, a metal complex compound, which can achieve both better handling property and suppression of firing unevenness, can be provided in the production of cathode active substances.

### DETAILED DESCRIPTION

The following describes the embodiments according to the present disclosure in detail. Note that, the following embodiments are examples of some typical embodiments of the present disclosure, and various modifications can be added to the scope of the present disclosure.

### <Metal Complex Compound>

The metal complex compound of the present disclosure is a secondary particle formed by aggregating a plurality of primary particles. The particle shape of the metal complex compound is not particularly limited, and may have a wide variety of shapes. Examples of the particle shape can include, for example, a substantially spherical shape and a substantially oval shape.

A metal complex compound of the present disclosure is a metal complex compound including at least nickel and an element M2. In a volume-based particle size distribution of particles of such a metal complex compound, when a particle diameter at a cumulative volume proportion of 10% from a small particle side is designated as D10 and a particle diameter at a cumulative volume proportion of 90% from the small particle side is designated as D90, a ratio (S90/S10) of an average solidity (S90) at the D90 to an average solidity (S10) at the D10 is adjusted so as to be larger than 1.000.

In the metal complex compound of the present disclosure, a ratio (S90/S10) of the average solidity in a predetermined volume particle size distribution is larger than 1.000, which results in an increased proportion of precursors, in which particle shapes of small particles are distorted and the particles approach spherical shapes as the particle size increases. As described above, controlling the shape distribution of particles from the viewpoint of the solidity can control compressibility that will be described later within an appropriate range. As a result, since the fluidity of the metal complex compound powder is improved, a metal complex compound that can achieve both a good handling property and suppression of firing unevenness can be provided.

The volume particle size distribution of the metal complex compound of the present disclosure can be determined by the volume of particles measured by static image analysis. Specifically, the static image analysis can be performed by a static automatic image analyzing device. By the static automatic image analyzing device, each particle is observed using an optical microscope, and an image is obtained. The obtained image is analyzed, and a projected area diameter of each particle is automatically calculated. Then, from the calculated projected area diameter, a volume-based particle size distribution is obtained. The obtained particle size distribution includes a particle diameter D5 at a cumulative volume proportion of 5% from the small particle side (hereinafter, also referred to as “D5”), a particle diameter D10 at a cumulative volume proportion of 10% from the small particle side (hereinafter, also referred to as “D10”), a particle diameter D50 at a cumulative volume proportion of 50% from the small particle side (hereinafter, also referred to as “D50”), and a particle diameter D90 at a cumulative volume proportion of 90% from the small particle side (hereinafter, also referred to as “D90”).

The D5 of the metal complex compound is not particularly limited, and an upper limit value of the D5 is preferably 9.0 μm or less, and more preferably 8.7 μm or less. On the other hand, a lower limit value of the D5 is preferably 3.0 μm or more, and more preferably 3.4 μm or more. The upper limit value and the lower limit value of the D5 of the metal complex compound described above can be optionally combined. Examples of the combinations of the D5 of the metal complex compound are 3.0 μm or more and 9.0 μm or less, and 3.4 μm or more and 8.7 μm or less.

The D10 of the metal complex compound is not particularly limited, and an upper limit value of the D10 is preferably 9.0 μm or less, and more preferably 8.9 μm or less. On the other hand, a lower limit value of the D10 is preferably 5.0 μm or more, and more preferably 5.6 μm or more. The upper limit value and the lower limit value of the D10 of the metal complex compound described above can be optionally combined. Examples of the combinations of the D10 of the metal complex compound are 5.0 μm or more and 9.0 μm or less, and 5.6 μm or more and 8.9 μm or less.

The D50 of the metal complex compound is not particularly limited, and an upper limit value of the D50 is preferably 15.0 μm or less, and more preferably 14.2 μm or less. On the other hand, a lower limit value of the D50 is preferably 9.0 μm or more, and more preferably 9.1 μm or more. The upper limit value and the lower limit value of the D50 of the metal complex compound described above can be optionally combined. Examples of the combinations of the D50 of the metal complex compound are 9.0 μm or more and 15.0 μm or less, and 9.1 μm or more and 14.2 μm or less.

The D90 of the metal complex compound is not particularly limited, and an upper limit value of the D90 is preferably 26.0 μm or less, and more preferably 25.3 μm or less. On the other hand, a lower limit value of the D90 is preferably 17.0 μm or more, and more preferably 17.2 μm or more. The upper limit value and the lower limit value of the D90 of the metal complex compound described above can be optionally combined. Examples of the combinations of the D90 of the metal complex compound are 17.0 μm or more and 26.0 μm or less, and 17.2 μm or more and 25.3 μm or less.

The average solidity in a predetermined volume particle size distribution of the metal complex compound is a parameter that represents the roughness of the particle surface, and can be calculated by simplifying the particle shape to a certain extent and dividing an area of the actual figure by the simplified area. A distorted shape results in a lower solidity. Therefore, the roughness of the particle surface and the degree of aggregation of particles can be evaluated by calculating an average solidity.

The average solidity is also measured by the static image analysis. The static image analysis can be performed by a static automatic image analyzing device. The static automatic image analyzing device can photograph a particle image of each particle, and the solidity can be measured by the obtained particle image.

In a static image of particles of the metal complex compound, the measurement field of view is changed until a total of 1,000 particles are measured, and automatic extraction of particles and measurement of the particle diameter and the solidity are repeated. In the measured volume-based particle size distribution of particles, the respective particle diameters D5, D10, D50, and D90 are calculated. The solidities of the calculated particle diameters are extracted and averaged to calculate the respective average solidities (S5), (S10), (S50), and (S90).

The average solidity (S5) at the D5 of the metal complex compound is not particularly limited, and, for example, an upper limit value of the S5 is preferably 0.993 or less, and more preferably 0.992 or less. On the other hand, a lower limit value of the S5 is preferably 0.950 or more, and more preferably 0.980 or more from the viewpoint of suppressing aggregation of particles. The upper limit value and the lower limit value of the average solidity (S5) described above can be optionally combined. As examples of the combinations, the average solidity (S5) is preferably 0.950 or more and 0.993 or less, and more preferably 0.980 or more and 0.992 or less.

In the metal complex compound of the present disclosure, a ratio (S90/S10) of the average solidity (S90) at D90 to the average solidity (S10) at the D10 is larger than 1.000. When the ratio (S90/S10) of the average solidity is larger than 1.000, the compressibility can be controlled within an appropriate range. Here, the compressibility represents a degree of compression when the powder of the metal complex compound is tapped, and is calculated by the following formula.

$$\\ Compressibility [ \% ] = [ ( tap density - bulk density ) / tap density ] \times 100$$

A high compressibility results in poor fluidity of the metal complex compound powder in the production of the cathode active substance, and the handling property tends to be deteriorated due to occurrence of sieving clogging or blockage caused by a bridge in a hopper, and the like. On the other hand, a low compressibility results in good fluidity of the metal complex compound powder in the production of the cathode active substance, but the packing ability is increased when the powder is packed in a sagger in the firing step, and this makes it difficult for oxygen to reach the entire sagger (gaps between particles), potentially causing the firing unevenness. Therefore, controlling the ratio (S90/S10) of the average solidity particularly to a value larger than 1.000 can control the compressibility to an appropriate range, preferably a range of 20 to 25%. As a result, the fluidity of the metal complex compound powder can be appropriately controlled, and therefore a metal complex compound that can achieve both a good handling property and suppression of firing unevenness can be provided.

The ratio (S90/S10) of the average solidity is not particularly limited, but an upper limit value of the ratio (S90/S10) is preferably 1.020 or less, and more preferably 1.017 or less. On the other hand, a lower limit value of the ratio (S90/S10) is preferably 1.001 or more, and more preferably 1.002 or more. The upper limit value and the lower limit value of the ratio (S90/S10) of the average solidity described above can be optionally combined. As examples of the combinations, the ratio (S90/S10) of the average solidity is preferably 1.001 or more and 1.020 or less, and more preferably 1.002 or more and 1.017 or less.

The metal complex compound of the present disclosure includes at least nickel (Ni) and an element M2, and the element M2 preferably includes at least one kind of element selected from the group consisting of aluminum (Al), magnesium (Mg), calcium (Ca), strontium (Sr), barium (Ba), titanium (Ti), zirconium (Zr), vanadium (V), niobium (Nb), chromium (Cr), molybdenum (Mo), tungsten (W), iron (Fe), ruthenium (Ru), copper (Cu), zinc (Zn), boron (B), gallium (Ga), silicon (Si), tin (Sn), phosphorus (P), and bismuth (Bi), and more preferably further includes cobalt (Co).

The metal complex compound of the present disclosure preferably satisfies the following compositional formula (A).

$$Ni {(}_{1 - x \_ y} ) M {1}_{x} M {2}_{y} {{O}_{z} ( OH )}_{2 - t} \qquad ( A )$$

(in the compositional formula (A), 0≤x≤0.7, 0<y≤0.2, 0≤z≤3, −0.5≤t≤2, and t−z<2 are satisfied,
M1 is one or more kinds of elements selected from Co and Mn, and is preferably Co,
M2 is one or more kinds of elements selected from the group consisting of Al, Mg, Ca, Sr, Ba, Ti, Zr, V, Nb, Cr, Mo, W, Fe, Ru, Cu, Zn, B, Ga, Si, Sn, P, and Bi, and preferably includes at least Al.)

The lower limit value of x is preferably 0.01 or more, more preferably 0.02 or more, and particularly preferably 0.03 or more. The upper limit value of x is more preferably 0.30 or less, still more preferably 0.20 or less, and particularly preferably 0.15 or less. The lower limit value and the upper limit value of x can be optionally combined. As examples of the combinations, x is more preferably 0.01 or more and 0.30 or less, still more preferably 0.02 or more and 0.20 or less, and particularly preferably 0.03 or more and 0.15 or less.

The lower limit value of y is more preferably 0.001 or more, and still more preferably 0.002 or more. The upper limit value of y is more preferably 0.19 or less, still more preferably 0.18 or less, and particularly preferably 0.17 or less. The lower limit value and the upper limit value of y can be optionally combined.

The metal complex compound of the present disclosure can be used as a precursor (hydroxide or oxide) of a cathode active substance of a nonaqueous electrolyte secondary battery such as a lithium-ion secondary battery.

### <Production Method of Metal Complex Compound>

The method for producing the metal complex compound of the present embodiment includes a reaction step of continuously supplying, to a reaction vessel, a metal-containing aqueous solution that contains nickel, an aqueous solution that contains the element M2, a complexing agent, and an alkaline aqueous solution, and subjecting them to crystallization reaction, to obtain a metal complex compound. In this case, the obtained metal complex compound is a metal composite hydroxide. The metal composite hydroxide can be produced by a known batch-type co-precipitation method or continuous co-precipitation method. When a metal complex oxide is produced as the metal complex compound, the obtained metal composite hydroxide may be oxidized.

As a specific example, by a co-precipitation method, a metal-containing aqueous solution that contains nickel, containing a nickel salt (for example, a sulphate) and a cobalt salt (for example, a sulphate) as a metal salt of an element M1 as an optional component, an aqueous solution of an aluminum salt (for example, a sulphate) as a metal salt of an element M2, an ammonium sulfate aqueous solution that is a complexing agent, and a sodium hydroxide aqueous solution that is an alkaline aqueous solution are appropriately added to a reaction vessel and are mixed, and the reaction solutions are appropriately stirred and are subjected to co-precipitation reaction, to prepare a metal complex compound, thereby obtaining a slurry suspension containing such a metal complex compound. Note that, as the metal-containing aqueous solution that contains nickel, the element M2 is not added to the solutions, and another solution that contains no nickel as a main component is added to the reaction vessel. As a result, the shape such as the solidity of small particles can be easily controlled. As a solvent of the suspension, for example, water is used.

In the following description, the metal-containing aqueous solution that contains nickel is abbreviated as “first aqueous solution”, and the aqueous solution that contains the element M2 is abbreviated as the “second aqueous solution”. The first aqueous solution is an aqueous solution that contains nickel, and the second aqueous solution is an aqueous solution that contains no nickel.

As the nickel salt that is the solute of the nickel salt solution, for example, one or more kinds of nickel sulfates, nickel nitrates, nickel chlorides, and nickel acetates can be used.

As the metal salt that is the solute of the metal salt solution of the element M1, for example, cobalt sulfates, cobalt nitrates, cobalt chlorides, cobalt acetates, manganese sulfates, manganese nitrates, manganese chlorides, manganese acetates, and the like can be used.

The salt of the addition element that is the solute of the addition element solution of the element M2 can be, for example, aluminum sulfates, sodium aluminate, sulphates, nitrates, chlorides, acetates, and the like can be used.

The complexing agent is not particularly limited as long as it is capable of forming a complex between ions of the main metal element and ions of the addition element in a solution such as an aqueous solution. Examples of the complexing agent include an ammonium ion donor. Examples of the ammonium ion donor include, for example, ammonium sulfates, ammonium chlorides, ammonium carbonates, and ammonium fluorides.

The alkaline aqueous solution is not particularly limited as long as the pH value of the aqueous solution is adjusted in the co-precipitation. Examples of the alkaline aqueous solution include, for example, aqueous solutions of alkali metal hydroxides (for example, sodium hydroxide, potassium hydroxide).

In order to add a solution that contains nickel and the element M1 (hereinafter, also referred to as the first aqueous solution) and a solution that contains the element M2 (hereinafter, also referred to as the second aqueous solution) separately, each solution is added to the reaction vessel at a position apart from the reaction vessel, to control a drop distance. Accordingly, the drop distances of the first aqueous solution and the alkaline aqueous solution are also controlled. Using a solution in which the first aqueous solution and the second aqueous solution are mixed, when the mixed aqueous solution is added to the reaction vessel, a ratio ((i)/(ii)) of a drop distance (i) between the first aqueous solution and the second aqueous solution to a drop distance (ii) between the above-described first aqueous solution and the alkaline aqueous solution is 0.

In the neutralization reaction, the concentrations of metal elements in each solution supplied to the reaction vessel are preferably each adjusted to 5 g/L or more and 120 g/L or less. For example, when a nickel salt solution, a solution of one kind of metal salt (M2 salt) derived from the element M2 that is an essential component, and a solution of one kind of metal salt (M1 salt) that is an optional component are each supplied to the reaction vessel in the neutralization reaction, the concentrations of the nickel salt solution, the M2 salt solution, and the M1 salt solution are preferably each adjusted to 5 g/L or more and 120 g/L or less. Furthermore, when two or more kinds of mixed aqueous solutions are each supplied in the neutralization reaction, the concentrations of the metal elements contained in each mixed aqueous solution are preferably each adjusted to 5 g/L or more and 120 g/L or less.

In the neutralization reaction, the temperature of the reaction vessel is controlled within a range of, for example, 20° C. to 85° C., and preferably 30 to 70° C. When a pH adjuster and, if necessary, an ammonium ion donor are supplied to the reaction vessel and are subjected to neutralization reaction, the concentration of the ammonia in the mixed solution in the reaction vessel is controlled to preferably 1.0 g/L or more and 11.0 g/L or less, and more preferably 1.5 g/L or more and 10.0 g/L or less. Furthermore, the pH of the mixed solution based on a solution temperature of 40° C. is controlled to preferably 9.0 or more and 13.0 or less, and more preferably 9.5 or more and 12.8 or less.

Examples of the reaction vessel used in the method for producing the metal complex compound of the present disclosure can include, for example, a continuous reaction vessel that allows the particles of the metal complex compound to overflow from an overflow pipe in order to separate the obtained metal complex compound to thereby collect the particles of the metal complex compound as a product, and a reaction vessel of batch type that does not discharge the particles of the metal complex compound from the system until the reaction is completed.

The obtained slurry containing the metal complex compound that is discharged from the overflow after the co-precipitation reaction in the continuous reaction vessel, is filtered and is further washed with an alkaline aqueous solution to remove impurities (e.g., SO₄ components) contained in the metal complex compound. Then, the slurry was washed with water and is subjected to a drying treatment, and the metal complex compound of the present disclosure can be obtained.

### <Cathode Active Substance>

Next, a cathode active substance of a nonaqueous electrolyte secondary battery that includes the metal complex compound of the present disclosure as a precursor (hereinafter, also referred to simply as “cathode active substance”) will be described. The cathode active substance is an aspect in which the metal complex compound of the present disclosure that is the precursor is fired with, for example, a lithium compound. The crystalline structure of the cathode active substance is a layered structure, and is preferably a trigonal crystalline structure, a hexagonal crystalline structure, or a monoclinic crystalline structure from the viewpoint of obtaining a secondary battery having a high discharge capacity.

The cathode active substance that includes the metal complex compound of the present disclosure as a precursor can be used, for example, as a cathode active substance of a nonaqueous electrolyte secondary battery such as a lithium-ion secondary battery.

Next, a method for producing the cathode active substance that includes the metal complex compound of the present disclosure as a precursor will be described. For example, in the method for producing the cathode active substance that includes the metal complex compound as the precursor, first, a lithium compound is added to a metal complex compound, to prepare a mixture of the metal complex compound and the lithium compound. The lithium compound is not particularly limited as long as it is a compound including lithium, and examples of the lithium compound include, for example, lithium carbonate and lithium hydroxide.

A mixture ratio between the metal complex compound and the lithium compound can be appropriately adjusted so that, for example, a cathode active substance, in which a molar ratio of lithium of the lithium compound relative to a molar ratio of a total amount of metals contained in the metal complex compound is a desired molar ratio, is obtained.

Next, the above-described mixture can be fired to produce a cathode active substance. As the firing condition, for example, a firing temperature of 500° C. or more and 1000° C. or less is preferable, and a rate of temperature increase of 50° C./h or more and 300° C./h or less is preferable, and a firing time of 5 hours or more and 20 hours or less is preferable. Examples of the firing atmosphere include, for example, atmosphere and oxygen. In addition, a firing furnace used for firing is not particularly limited, and examples of the firing furnace include a static box furnace and a continuous furnace of roller hearth type.

Next, Examples of the present disclosure will be described, but the present disclosure is not limited to these Examples as long as it does not depart from its subject matter.

### Example 1

After water was added to a reaction vessel equipped with a rotary type stirring device having a stirring blade and an overflow pipe, a sodium hydroxide aqueous solution was added. A first aqueous solution 1 adjusted by mixing a nickel sulfate aqueous solution and a cobalt sulfate aqueous solution, and an aluminum sulfate aqueous solution as a second aqueous solution 1 were adjusted. Next, the first aqueous solution 1 and the second aqueous solution 1 were each added dropwise to the reaction vessel under stirring from different supply ports so that the composition of the metal complex compound to be obtained was nickel:cobalt:aluminum=91:4:5 in a molar ratio, and, at the same time, an ammonium sulfate aqueous solution as a complexing agent and a sodium hydroxide aqueous solution as an alkaline aqueous solution were added dropwise, followed by a crystallization step. In the crystallization step, each solution was added dropwise so that a value of the [the drop distance (i) between the first aqueous solution 1 and the second aqueous solution 1/the drop distance (ii) between the first aqueous solution 1 and the alkaline aqueous solution] was 1.47. While the solution temperature of the mixed solution in the reaction vessel was maintained at 54° C. and the pH of the mixed solution in the reaction vessel based on the solution temperature of 40° C. was maintained at 11.68, continuous stirring was performed. The metal-containing hydroxide crystallized by the neutralization reaction is allowed to overflow from the overflow pipe of the reaction vessel, to be extracted as a suspension of the metal-containing hydroxide. As described above, the extracted suspension of the metal-containing hydroxide was filtered, and was washed with an alkaline aqueous solution, followed by a solid-liquid separation. Then, the separated solid phase was washed with water, and was subjected to the respective treatments such as dehydration and drying, to obtain a metal complex compound 1.

### Example 2

After water was added to a reaction vessel equipped with a rotary type stirring device having a stirring blade and an overflow pipe, a sodium hydroxide aqueous solution was added. A first aqueous solution 2 adjusted by mixing a nickel sulfate aqueous solution and a cobalt sulfate aqueous solution, and an aluminum sulfate aqueous solution as a second aqueous solution 2 were adjusted. Next, the first aqueous solution 2 and the second aqueous solution 2 were each added dropwise to the reaction vessel under stirring from different supply ports so that the composition of the metal complex compound to be obtained was nickel:cobalt:aluminum=87:9:4 in a molar ratio, and, at the same time, an ammonium sulfate aqueous solution as a complexing agent and a sodium hydroxide aqueous solution as an alkaline aqueous solution were added dropwise, followed by a crystallization step. In the crystallization step, each solution was added dropwise so that a value of the [the drop distance (i) between the first aqueous solution 2 and the second aqueous solution 2/the drop distance (ii) between the first aqueous solution 2 and the alkaline aqueous solution] was 1.45. While the solution temperature of the mixed solution in the reaction vessel was maintained at 40° C. and the pH of the mixed solution in the reaction vessel based on the solution temperature of 40° C. was maintained at 12.13, continuous stirring was performed. The subsequent steps were performed in the similar manner as in Example 1, to obtain a metal complex compound 2.

### Example 3

After water was added to a reaction vessel equipped with a rotary type stirring device having a stirring blade and an overflow pipe, a sodium hydroxide aqueous solution was added. A first aqueous solution 3 adjusted by mixing a nickel sulfate aqueous solution, a cobalt sulfate aqueous solution, and a manganese sulfate aqueous solution, and an aluminum sulfate aqueous solution as a second aqueous solution 3 were adjusted. Next, the first aqueous solution 3 and the second aqueous solution 3 were each added dropwise to the reaction vessel under stirring from different supply ports so that the composition of the metal complex compound to be obtained was nickel:cobalt:manganese:aluminum=89:5:5:1 in a molar ratio, and, at the same time, an ammonium sulfate aqueous solution as a complexing agent and a sodium hydroxide aqueous solution as an alkaline aqueous solution were added dropwise, followed by a crystallization step. In the crystallization step, each solution was added dropwise so that a value of the [the drop distance (i) between the first aqueous solution 3 and the second aqueous solution 3/the drop distance (ii) between the first aqueous solution 3 and the alkaline aqueous solution] was 0.48. While the solution temperature of the mixed solution in the reaction vessel was maintained at 70° C. and the pH of the mixed solution in the reaction vessel based on the solution temperature of 40° C. was maintained at 10.85, continuous stirring was performed. The subsequent steps were performed in the similar manner as in Example 1, to obtain a metal complex compound 3.

### Comparative Example 1

After water was added to a reaction vessel equipped with a rotary type stirring device having a stirring blade and an overflow pipe, a sodium hydroxide aqueous solution was added. A nickel sulfate aqueous solution, a cobalt sulfate aqueous solution, and a manganese sulfate aqueous solution were mixed to adjust a mixed aqueous solution 4. Next, the mixed aqueous solution 4 was added dropwise to the reaction vessel under stirring so that the composition of the metal complex compound to be obtained was nickel:cobalt:manganese=60:20:20 in a molar ratio, and, at the same time, an ammonium sulfate aqueous solution as a complexing agent and a sodium hydroxide aqueous solution as an alkaline aqueous solution were added dropwise, followed by a crystallization step. While the solution temperature of the mixed solution in the reaction vessel was maintained at 60° C. and the pH of the mixed solution in the reaction vessel based on the solution temperature of 40° C. was maintained at 11.80, continuous stirring was performed. The subsequent steps were performed in the similar manner as in Example 1, to obtain a metal complex compound 4.

### Comparative Example 2

After water was added to a reaction vessel equipped with a rotary type stirring device having a stirring blade and an overflow pipe, a sodium hydroxide aqueous solution was added. A nickel sulfate aqueous solution, a cobalt sulfate aqueous solution, and a manganese sulfate aqueous solution were mixed to adjust a mixed aqueous solution 5. Next, the mixed aqueous solution 5 was added dropwise to the reaction vessel under stirring so that the composition of the metal complex compound to be obtained was nickel:cobalt:manganese=90:5:5 in a molar ratio, and, at the same time, an ammonium sulfate aqueous solution as a complexing agent and a sodium hydroxide aqueous solution as an alkaline aqueous solution were added dropwise, followed by a crystallization step. While the solution temperature of the mixed solution in the reaction vessel was maintained at 70° C. and the pH of the mixed solution in the reaction vessel based on the solution temperature of 40° C. was maintained at 10.90, continuous stirring was performed. The subsequent steps were performed in the similar manner as in Example 1, to obtain a metal complex compound 5.

### Comparative Example 3

After water was added to a reaction vessel equipped with a rotary type stirring device having a stirring blade and an overflow pipe, a sodium hydroxide aqueous solution was added. A first aqueous solution 6 adjusted by mixing a nickel sulfate aqueous solution, a cobalt sulfate aqueous solution, and an aluminum sulfate aqueous solution, and an aluminum sulfate aqueous solution as a second aqueous solution 6 were adjusted. Next, the first aqueous solution 6 and the second aqueous solution 6 were each added dropwise to the reaction vessel under stirring from different supply ports so that the composition of the metal complex compound to be obtained was nickel:cobalt:aluminum=91:4:5 in a molar ratio, and, at the same time, an ammonium sulfate aqueous solution as a complexing agent and a sodium hydroxide aqueous solution as an alkaline aqueous solution were added dropwise, followed by a crystallization step. In the crystallization step, each solution was added dropwise so that a value of the [the drop distance (i) between the first aqueous solution 6 and the second aqueous solution 6/the drop distance (ii) between the first aqueous solution 6 and the alkaline aqueous solution] was 0. While the solution temperature of the mixed solution in the reaction vessel was maintained at 70° C. and the pH of the mixed solution in the reaction vessel based on the solution temperature of 40° C. was maintained at 11.55, continuous stirring was performed. The subsequent steps were performed in the similar manner as in Example 1, to obtain a metal complex compound 6.

The measurements and the evaluation items of the metal complex compounds 1 to 6 prepared in Examples 1 to 3 and Comparative Examples 1 to 3 are as follows.

### (1) Compositional Analysis

After the obtained metal complex compound was dissolved in hydrochloric acid, the compositional analysis was performed using an inductively coupled plasma emission analysis device (“Optima8300” available from PerkinElmer Japan G.K.).

### (2) Average Solidity

Regarding the average solidity of the metal complex compound, using MORPHOLOGI 4 available from Malvern Panalytical as a static automatic image analyzing device, the measurement field of view was changed until a total of 1,000 particles were measured, and automatic extraction of particles and measurement of the particle diameter and the solidity were repeated. In the volume-based particle size distribution of particles measured, a particle diameter D5 at a cumulative volume proportion of 5% from the small particle side, a particle diameter D10 at a cumulative volume proportion of 10% from the small particle side, and a particle diameter D90 at a cumulative volume proportion of 90% from the small particle side were each calculated. Then, the solidities satisfying the obtained D5, D10, and D90 were extracted, and were averaged to calculate each of the average solidities (S5), (S10), and (S90). Moreover, from the obtained values of S10 and S90, a ratio (S90/S10) of S90 to S10 was calculated.

### (3) Compressibility

A tap denser (“KYT-4000” available from SEISHIN Enterprise Co., Ltd.) was used to measure the tap density by the constant mass measurement method among the approaches described in JIS R 1628-1997.

The metal complex compound was allowed to free-fall and was filled in a vessel. The bulk density was measured from the volume of the vessel and mass of the metal complex compound. The tap density and the bulk density obtained were substituted into the following formula to calculate the compressibility (%).

$$\\ Compressibility [ \% ] = [ ( tap density - bulk density ) / tap density ] \times 100$$

### (4) Ratio of Drop Distance

A nickel-containing solution and a solution containing the element M2 were each added dropwise at a position spaced apart from the vessel, and the drop distance (i) was measured. The nickel-containing solution and an alkaline aqueous solution were each added dropwise at a position spaced apart from the vessel, and the drop distance (ii) was measured. Based on each drop distance, a ratio of the drop distance ((i)/(ii)) was calculated.

The evaluation results of the measurement and physical properties of the metal complex compounds prepared in Examples 1 to 3 and Comparative Examples 1 to 3 are shown in Table 1.

TABLE 1

| | | | | | | | | Ratio of drop |
|---|---|---|---|---|---|---|---|---|
| | Composition [mol %] | | | | Average solidity | | Compressibility | distance |
| | Ni | Co | Mn | Al | S5 | S90/S10 | [%] | (I)/(II) |
| Example 1 | 91 | 4 | | 5 | 0.989 | 1.007 | 22.3 | 1.47 |
| Example 2 | 87 | 9 | | 4 | 0.987 | 1.012 | 23.5 | 1.45 |
| Example 3 | 89 | 5 | 5 | 1 | 0.991 | 1.004 | 20.8 | 0.48 |
| Comparative Example 1 | 60 | 20 | 20 | | 0.993 | 0.969 | 38.3 | — |
| Comparative Example 2 | 90 | 5 | 5 | | 0.995 | 0.996 | 17.8 | — |
| Comparative Example 3 | 91 | 4 | | 5 | 0.992 | 0.987 | 26.8 | 0 |

From Table 1, in the metal complex compounds of Examples 1 to 3, where ratios of S90/S10 are larger than 1.000, each compressibility can be controlled within an appropriate range of 20 to 25%. As a result, since the fluidity of the metal complex compound powder is appropriately controlled, the metal complex compound that can achieve both a good handling property and suppression of firing unevenness can be provided. Each of the metal complex compounds of Examples 1 to 3 showed a value larger than 0 of the ratio ((i)/(ii)) of drop distance. This result is presumably due to the fact that the nucleation of the element M2 as a hydroxide occurs at a position apart from nickel, and therefore the shape of the obtained small particles is easily distorted.

On the other hand, each of the metal complex compounds of Comparative Examples 1 and 3, where ratios of S90/S10 are 0.969 and 0.981, showed a higher compressibility, that is, a compressibility of more than 25%. Therefore, in the metal complex compounds of Examples 1 and 3, the metal complex compound powder has poor fluidity, and causes occurrence of sieving clogging or a bridge in a hopper and the like in the production of the cathode active substance, which may raise a concern about a deteriorated handling property.

In addition, the metal complex compound of Comparative Example 2, where the ratio of S90/S10 was 0.996, showed a lower compressibility, that is, a compressibility of less than 20%. Therefore, in the metal complex compound of Comparative Example 2, the metal complex compound powder has a good fluidity, but has a high packing ability when packed in a sagger in the production of the cathode active substance, and this makes it difficult for oxygen to reach the entire sagger in the firing step, which may raise a concern about occurrence of the firing unevenness.

Furthermore, the metal complex compound of Comparative Example 3 showed a ratio ((i)/(ii)) of drop distance of 0. This result is presumably due to the fact that the M2-containing solution is added together into the nickel-containing solution, simultaneous nucleation of a hydroxide containing nickel and the M2 occurs, and therefore the obtained small particles easily tend to be spherical.

The metal complex compound of the present disclosure has excellent reactivity with lithium compounds during the production of cathode active substances, making it applicable in a wide range of fields, including secondary batteries for portable devices and vehicles.

What is claimed is:

1. A metal complex compound comprising at least nickel and an element M2,
wherein the element M2 is at least one kind of element selected from the group consisting of Al, Mg, Ca, Sr, Ba, Ti, Zr, V, Nb, Cr, Mo, W, Fe, Ru, Cu, Zn, B, Ga, Si, Sn, P, and Bi, and
wherein, in a volume-based particle size distribution of particles of the metal complex compound, obtained by measuring powder of the metal complex compound by static image analysis, when a particle diameter at a cumulative volume proportion of 10% from a small particle side is designated as D10 (μm) and a particle diameter at a cumulative volume proportion of 90% from the small particle side is designated as D90 (μm), a ratio (S90/S10) of an average solidity (S90) at the D90 to an average solidity (S10) at the D10 is larger than 1.000.

2. The metal complex compound according to claim 1, wherein the ratio (S90/S10) is less than 1.020.

3. The metal complex compound according to claim 1, wherein when a particle diameter at a cumulative volume proportion of 5% from the small particle side is designated as D5 (μm) in the particle size distribution, an average solidity (S5) at the D5 is 0.993 or less.

4. The metal complex compound according to claim 1, which satisfies a compositional formula (A) described below,
$$Ni {(}_{1 - x \_ y} ) M {1}_{x} M {2}_{y} {{O}_{z} ( OH )}_{2 - t} \qquad ( A )$$
wherein, in the compositional formula (A), 0≤x≤0.7, 0<y≤0.2, 0≤z≤3, −0.5≤t≤2, and t−z<2 are satisfied,
M1 is one or more kinds of elements selected from Co and Mn, and
M2 is one or more kinds of elements selected from the group consisting of Al, Mg, Ca, Sr, Ba, Ti, Zr, V, Nb, Cr, Mo, W, Fe, Ru, Cu, Zn, B, Ga, Si, Sn, P, and Bi.

5. The metal complex compound according to claim 1, which is a precursor of a cathode active substance of a nonaqueous electrolyte secondary battery.

6. A cathode active substance of a nonaqueous electrolyte secondary battery, which is obtained by firing the metal complex compound according to claim 1 with a lithium compound.
